(19) United States
(12) Patent Application Publication
(10) Pub. No.: US 2014/0004358 A1
(43) Pub. Date: Jan. 2, 2014

(54) LOW K CARBOSILANE FILMS

(71) Applicants: James M. Blackwell, Portland, OR (US); David J. Michalak, Portland, OR (US)

(72) Inventors: James M. Blackwell, Portland, OR (US); David J. Michalak, Portland, OR (US)

(21) Appl. No.: 13/535,993

(22) Filed: Jun. 28, 2012

(51) Int. Cl. C09D 183/02; B05D 3/06; B05D 3/00

(52) U.S. Cl. CPC C09D 183/02; B05D 3/007; B05D 3/067
USPC 428/447; 521/154; 427/397.7; 427/558

(57) ABSTRACT

Low k dielectric films/layers can be produced by cross-linking oligomers made from cyclic carbosilane monomers. The films may exhibit high porosity and strong resistance to chemical attack while also exhibiting improved hydrophobicity. Oligomers may be cross-linked in situ after coating on a substrate such as a silicon wafer. Resulting cross-linked layers may be further treated to improve chemical resistance and reduce water uptake.

### BACKGROUND

The desire to make smaller integrated circuit chips (IC chips) continuously places demands on the methods and materials used to manufacture these devices. IC chips may also be referred to as microchips, silicon chips or simply chips. IC chips are used in a variety of devices including automobiles, computers, appliances, mobile phones and consumer electronics. A plurality of IC chips can typically be formed on a single silicon wafer (a silicon disk having a diameter of, for example, 300 mm) which is then diced apart to create individual chips. IC chips can include features sizes on the nanometer scale and can comprise hundreds of millions of components. Improved materials and manufacturing techniques have reduced features sizes to, for example, less than 45 nm.

### BRIEF DESCRIPTION OF THE DRAWINGS

FIG. 1 illustrates a cyclic carbosilane monomer that can be used to make precursor oligomers in accordance with an embodiment of the present invention.

FIG. 2 provides a schematic flow chart illustrating one pathway for producing a low k dielectric film in accordance with an embodiment of the present invention.

FIG. 3 provides chemical structures illustrating a cross-linked film, an oligomer from which the cross-linked film can be made and the monomer of FIG. 1, in accordance with an embodiment of the present invention.

FIG. 4 provides the chemical structures of four different TSCH derivatives each of which can serve as a monomer to make oligomer and low k film in accordance with an embodiment of the present invention.

FIGS. 5a through 5e provide chemical structures of different species that are representative of a cyclic carbosilane oligomer identified as “13a” that can be used in accordance with various embodiments of the present invention.

FIG. 6 illustrates a pathway for functionalizing a porogen in accordance with various embodiments of the present invention.

FIG. 7 illustrates a pathway for cross-linking four oligomer units to produce a solid cross-linked dielectric film in accordance with various embodiments of the present invention.

FIGS. 8a-8b each shows an example semiconductor structure configured with a low-k interlayer dielectric in accordance with an example embodiment of the present invention.

FIG. 9 illustrates a computing system implemented with one or more integrated circuits implemented with a low-k dielectric configured in accordance with an embodiment of the present invention.

### DETAILED DESCRIPTION

In one aspect, a dielectric material for integrated circuits includes cyclic carbosilane units. The material can be, for example, a dielectric film, a low-k dielectric film, a spin-on dielectric film, an interlayer dielectric film and/or an etch-selective layer. The film can be made from cyclic carbosilane precursors that can be applied to a substrate, for example a silicon wafer, by techniques such as spin coating or other suitable deposition processes such as vapor phase deposition. In some embodiments, the resulting film or layer can exhibit relatively low dielectric values (e.g., less than 2.2), may be hydrophobic, and can be resistant to chemical attack (such as chemicals used in typical integrated circuit fabrication processes). In some cases, the film can exhibit high porosity, for example, porosities of greater than 40, greater than 50 or greater than 60 percent, depending on the desired dielectric constant. The film may be treated after crosslinking to improve or otherwise customize dielectric constant, increase hydrophobicity, and render the film more resistant to chemical attack.

General Overview

Spin-on techniques for dielectric films often rely on sol-gel formation of Si—O—Si groups from precursors that include Si—OR groups. The resulting Si—O—Si groups form the backbone of the spun-on film. When these Si—O—Si based films are formed at porosities sufficiently high to provide low k values, the films become susceptible to chemical attack and cannot withstand dry etch and wet clean processes. Highly porous films also typically suffer from low mechanical strength due to their amorphous backbones. As described herein, and in accordance with an embodiment of the present invention, a high fraction of Si—C—Si structures in the film/layer can improve stability against chemical and chemical/mechanical processes such as etching and cleaning In addition, the high Si—C—Si content allows for repair of SiOH sites (damage sites) through internal rearrangement from, for example, Si—CH₂—Si—OH to Si—O—Si—CH₃. Many mechanisms for repair involve silylation that reduces porosity and thereby increases dielectric constant (k value) due to density increase. Additionally, the use of ringed carbosilane structures that are crosslinked via short Si—O—Si groups can provide a rigid backbone that exhibits high mechanical strength relative to other materials at similar porosity values. In some such embodiments, the films may incorporate porogens to provide for increased porosities and lower k vales. In additional embodiments, these porogens may be covalently bound to cyclic carbosilanes such as trisilacyclohexane (TSCH). This can prevent porogen agglomeration which results in pore sizes that are larger than desired (such as pore sizes greater than 4 nm). The porogens may be sacrificed or removed to provide pores in the film.

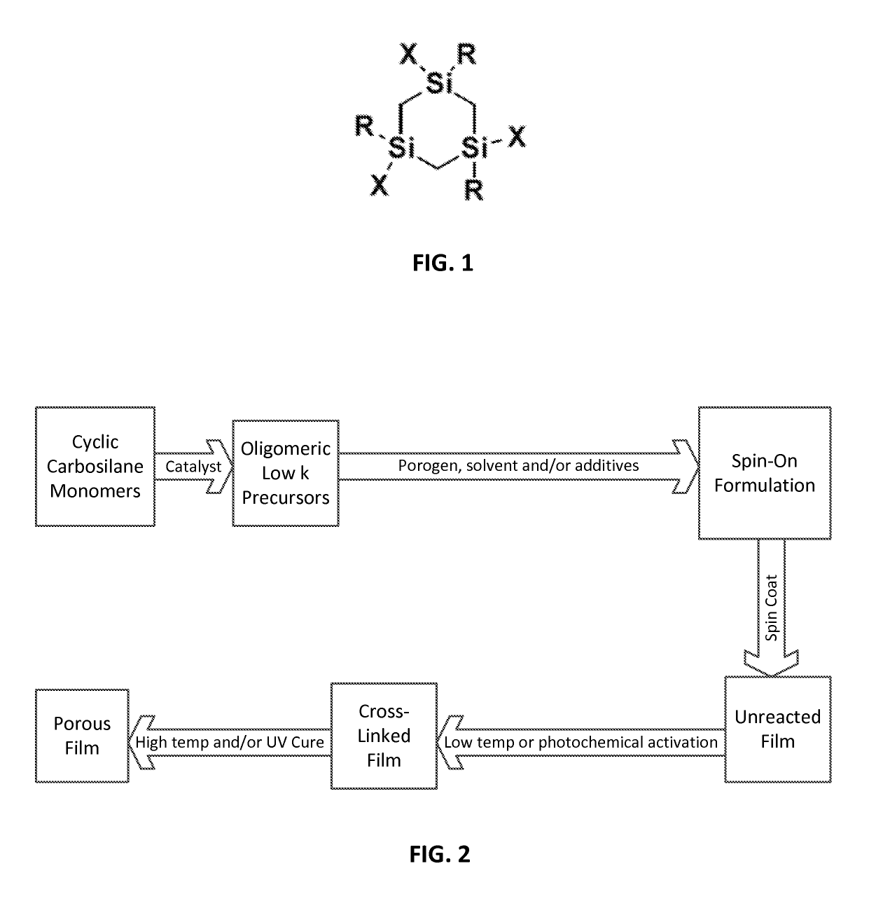

Cyclic carbosilanes can include rings having various numbers of cyclic members and may have equal numbers of Si and C atoms in the ring. The number of ring members may be, for example, 4, 6, 8, 10, 12, 14, or more. In one set of embodiments the film may be comprised of cyclic carbosilane units that consist of six member rings, each of which includes three carbon atoms and three silicon atoms in the ring. The cyclic carbosilanes may be void of cyclic atoms that are not Si or C. Low k dielectric films can be produced from oligomers made from two or more TSCH derivatives. The TSCH derivatives may be the same or different and may include different functional groups attached to the cyclic Si atoms. The cyclic carbons may also be functionalized or may be void of functional groups. In some embodiments, each cyclic Si atom in the TSCH unit may be independently bonded to an R group and a cross-linkable X group (FIG. 1). In some specific embodiments, R can be, for example, H, methyl, ethyl, O—CH₃ or O-Et. The R group attached to Si may be the same or different as X and may include, for example, H, alkyl or OR′ where R′ is a functional group, such as, for example, an alkyl group comprising hydrogen atoms and from 1 to 10 carbon atoms or from 1 to 30 carbon atoms. In addition, R′ optionally comprises heteroatoms such as oxygen atoms, nitrogen atoms, sulfur atoms, chlorine atoms, and or fluorine atoms. The functional group R′ can be a group such as, —CH₃, —CH₂CH₃, —CH₂CH₂CH₃, —CH₂CH₂CH₂CH₃, —CH₂CH₂CH₂CH₂CH₃, —CH₂CH(CH₃)₂, —CH₂CH₂CH(CH₃)₂, —CH₂CH₂CH(CH₂CH₃)₂, —CH₂OCH₃ and —CH₂CH₂OCH₃. R′ may also include phenyl groups, allyl groups and vinyl groups. Examples include C₆H₅—CH₂, CH₂═CHCH₂ and CH₂═CH. In certain embodiments R′ is a methyl group, ethyl group, or can be SiR″₃ where R″ can be the same or different and can be H or an alkyl group such as, for example, —CH₃, —CH₂CH₃, —C(CH₃)₃, —CH(CH₃)₂, —CH₂CH₂CH₃ or —CH₂CH₂CH₂CH₃. X can be a cross-linkable functional group such as H, OEt or O—CH₃. Examples of specific pairings of R and X bound to a common cyclic Si can include, for example, H, H; H, CH₃; O-Et, O-Et; CH₃, O-Et; and H, O-Et. The R X pairs may be independently selected for each cyclic Si in the cyclic carbosilane unit. In some embodiments, the R X pairs for each cyclic Si in a given unit are the same. Exemplary TSCH derivatives that may be useful as monomer units include 1,3,5-Trisilacyclohexane; 1,1,3,3,5,5-hexamethyl-1,3,5-trisilacyclohexane; 1,1,3,3,5,5-hexaethoxy-1,3,5-trisilacyclohexane; 1,3,5-trimethyl-1,3,5-trisilacyclohexane; 1,3,5-triethoxy-1,3,5-trimethyl-1,3,5-trisilacyclohexane; and 1,3,5-triethoxy-1,3,5-trisilacyclohexane.

In some embodiments, an oligomeric or cross-linked film may include a cyclic carbosilane unit that is bound to greater than two additional cyclic carbosilane units. In many embodiments, the film may include a cyclic carbosilane unit that is bound to greater than three additional carbosilane units. For instance, a single TSCH unit (or other cyclic carbosilane) may be covalently bound to three, four, five or six independent TSCH (or other cyclic carbosilane) units. The cyclic carbosilane units may be linked to each other via the cyclic carbon atoms or the cyclic silicon atoms on each of the respective rings. In some embodiments, adjacent cyclic carbosilane units are each linked to each other via cyclic silicon atoms. For example, a silicon atom of a six membered carbosilane ring may be linked to a silicon atom of an adjacent six membered ring via a linking group that may be a single atom such as oxygen. A cyclic carbosilane ring or unit is adjacent to another cyclic carbosilane ring or unit if it is covalently bonded to that ring or unit directly or via an atom or linking group that does not include an additional cyclic carbosilane ring or unit. In some embodiments, linking groups may be limited to, at most, 1, 2, 3, 4, 5, 6, 7, 8, 9, 10,11, or 12 atoms.

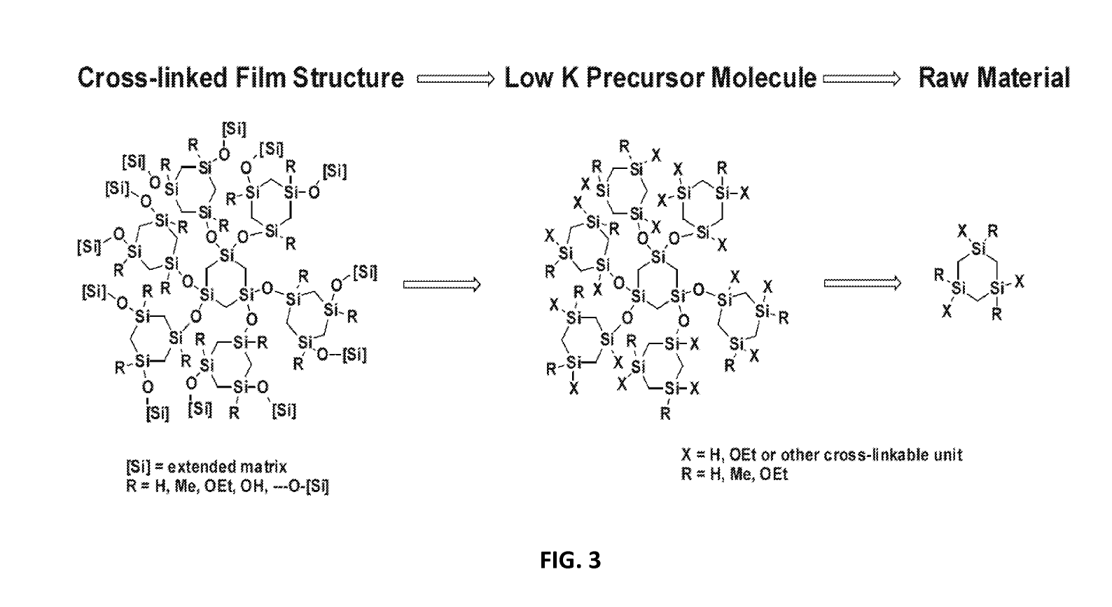

Cyclic carbosilane monomers, such as those described herein, may be used to produce dendrimeric oligomers (precursors) that in turn can be disposed on a substrate, such as a silicon wafer, to produce a film coating. The oligomeric film can be polymerized into a hard, cross-linked film. A flow chart illustrating some of the steps that can be used from monomer to a porous cross-linked layer, in accordance with some embodiments, is provided in FIG. 2. The dendrimeric precursor oligomers can be carried in a solvent such as toluene, 2-heptanone, or cyclohexanone. The oligomers can exhibit low volatility (lower than the cyclic carbosilane monomer or dimer, for instance) so that the oligomers can be disposed on and quantitatively retained on a substrate prior to being cross-linked. The film can then be cross-linked in situ to produce a cross-linked film on the substrate. A diagram illustrating the relationship between monomer raw material, low k precursor oligomer, and the low k cross-linked film, in accordance with some example embodiments, is provided in FIG. 3. The cross-linked film may be optionally treated further, such as through application of heat or radiation, to provide, for example, a porous film exhibiting low k values. Precursor and/or cross-linked films may exhibit average thicknesses of from 1 nm to 5 μm and in some embodiments may have average thicknesses of less than 1 μm, less than 500 nm, less than 100 nm, less than 50 nm, less than 20 nm or less than 10 nm. In other embodiments, the average thickness may be from 1 to 500 nm, from 1 to 100 nm, from 1 to 50 nm or from 1 to 20 nm. Porogens may be included in the layer to provide porosity and may be chemically attached, e.g., covalently, to the oligomers, or may be physically mixed or dispersed (but not chemically bound) with the oligomers.

Properties such as the average molecular weight of the dendrimeric oligomers can be pre-determined by controlling reaction conditions such as concentration of components (including monomers and catalyst), time of addition, solvent or co-solvents, and temperature. Molecular weights may be selected to improve the applicability of the precursor when spun onto a substrate. Exemplary average molecular weights for precursors may be greater than or equal to 280, greater than 500, greater than 1000, greater than 2000 or greater than 5000. The dendrimeric oligomers may include, for instance, dimers, trimers, tetramers, pentamers, hexamers, heptamers, octomers, nonomers, or may contain greater than 10, greater than 20 or greater than 30 cyclic carbosilane units. The precursors may be branched and may be essentially void of linear oligomers of greater than three or four monomer units. To provide for dendrimeric branching, some cyclic carbosilane units may be chemically bound to three, four, five or six adjacent cyclic carbosilane units. In some embodiments, two, three, four or more different oligomers may be physically mixed together and then coated onto a substrate. These oligomers may differ, for example, with regard to cyclic carbosilane structure, average molecular weight, molecular weight distribution, atomic percent C, atomic percent Si, atomic percent O, ratio of C:Si:O, amount of branching, capping species and/or porogen content.

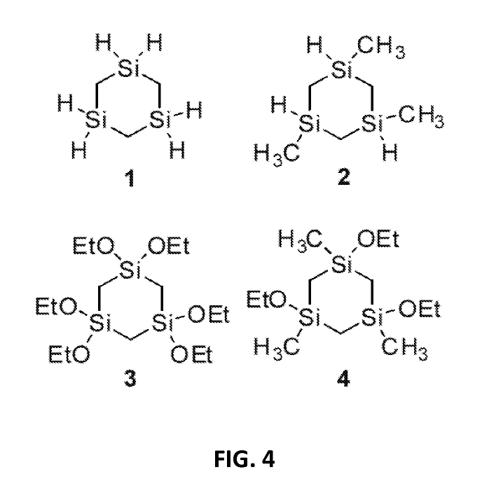

In one set of embodiments, different types of dendrimeric oligomers can be produced by joining TSCH derivatives in various ratios. The ratios are often not 1:1 on an equivalents basis. In certain embodiments, monomers may be reacted in ratios (equivalents basis) greater than or equal to 2:1, 3:1, 4:1, 5:1, 6:1, 7:1 or 8:1. FIG. 4 provides four examples of suitable monomeric cyclic carbosilanes that are either TSCH or TSCH derivatives. Monomers 1 and 2 are representative of Si—H functionalized species while monomers 3 and 4 are representative of Si—O-Et functionalized species. By selecting different cyclic carbosilanes and reacting them together in pre-selected ratios, a high molecular weight dendrimeric oligomer with tailored properties can be formed. For instance, the oligomer may be selectively capped substantially with Si—O-Et groups or substantially with Si—H or Si—H₂ groups. As used herein, an oligomer is substantially capped with a group if that group occupies more than 99% of the available Si locations. The presence or absence of these groups can be confirmed with the use of ¹H NMR. The cyclic carbosilane monomers can be reacted directly or may use a cross-linker To form Si—O—Si linkages from Si—H and Si—O-Et groups, a coupling agent such as a strong Lewis acid may be used. Examples of suitable strong Lewis acids include tris(pentafluorophenyl)borane (B(C₆F₅)₃).

Cyclic carbosilane monomers including Si—H groups can react with cyclic carbosilane monomers including Si—O-Et groups until the availability of one of the two groups is exhausted. Reaction may be facilitated in a dry, non-aqueous solvent system. Solvents may be hydrocarbons and may be either aliphatic or aromatic or a mixture. In some embodiments, aromatic solvents such as toluene, benzene, xylene or ethyl benzene may be used. By reacting a greater amount (equivalents basis) of an Si—H₂ (or Si—H) functionalized monomer with a lesser amount of an Si—O-Et functionalized monomer, an Si—H₂ (or Si—H) capped oligomer can be formed where all or essentially all of the O-Et groups have been converted to Si—O—Si linking groups that form the oligomer. Conversely, by reacting a greater amount of Si—O-Et functionalized monomer with a lesser amount of Si—H functionalized monomer, the resulting precursor oligomer can exhibit an absence of Si—H groups and a large number of Si—O-Et groups. Either oligomer termination may be useful for subsequent cross-linking or binding to an additional substance such as a porogen. If the limiting component includes Si—O-Et groups, the SiH or SiH₂ groups in the majority component will convert all, or substantially all, of the Si—O-Et groups to Si—O—Si linkages, evolving ethane in the process. If the limiting component includes

SiH and/or SiH₂ groups, then the resulting oligomer will be predominantly capped with Si—O-Et or Si—(OEt)₂ groups. Additional cyclic carbosilane monomers as well as other compounds may be incorporated to alter the structure of the oligomer precursors. For instance, the oligomer may be the product of two, three, four or more different monomers.

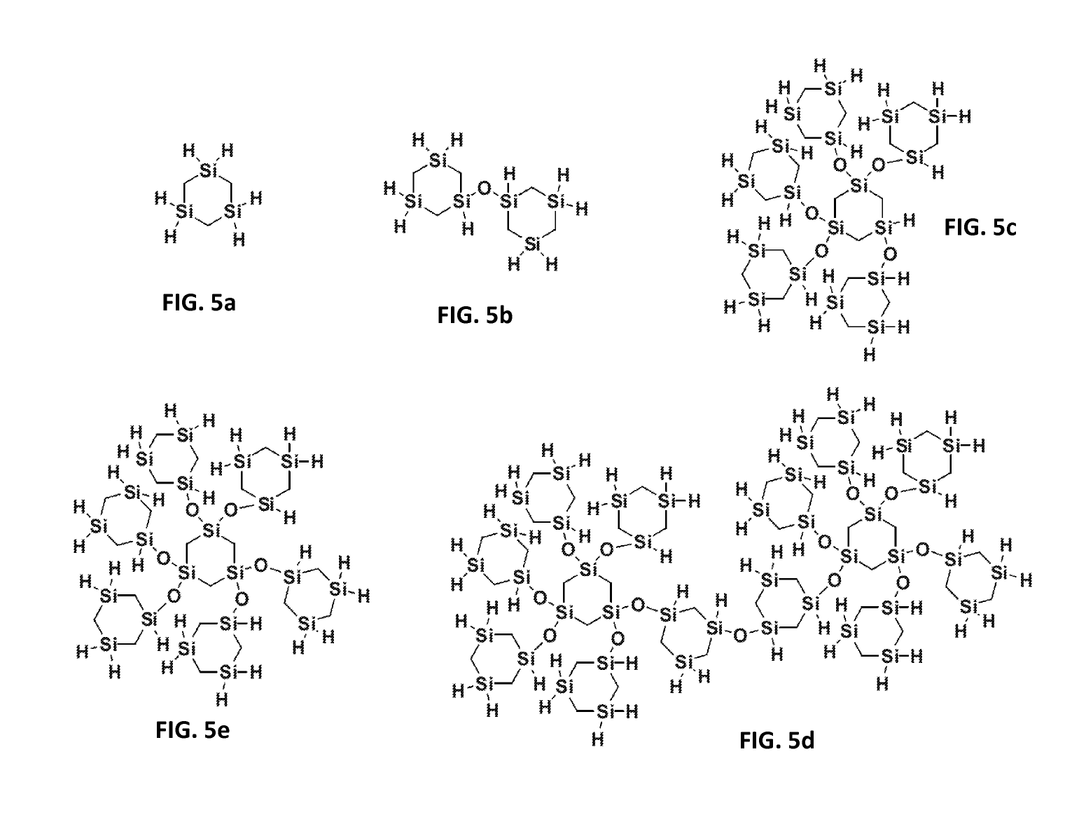

The synthesis of a dendrimeric oligomer precursor produced by combining cyclic carbosilane “1” with cyclic carbosilane “3” (as shown in FIG. 4) is illustrated in equation 1, below, in which 6 equivalents of monomer 1 are reacted with 1 equivalent of monomer 3 in a solvent in the presence of B(C₆F₅)₃. As the ratio of monomer 1 to monomer 3 (equivalents basis) is 6:1, all Si—O-Et groups are converted to Si—O—Si linking groups and the resulting oligomer is SiH₂ capped. Examples of several species that are representative of oligomer 13a are illustrated by the structures shown in FIGS. 5a-5e. As illustrated, some of the cyclic carbosilane units are covalently bonded to five or six adjacent cyclic carbosilane units. Although the number of monomer units in each of these species of oligomer 13a can vary, each Si forms either a Si—O—Si linking group or retains an SiH₂ group, and Si—O-Et groups are essentially absent. A group is “essentially absent” if it represents less than 0.1% of the Si groups in the oligomer.

Equations 2 through 8 represent additional embodiments in which different precursor oligomers with various capping species can be chosen by pre-selecting the ratio of monomers to be reacted. Each pairing reacts a monomer including Si—H functional groups with an unequal (on equivalents basis) amount of a monomer including Si—O-Et functional groups. The resulting oligomers are identified and the predominant capping species is indicated.

| Equation | Oligomer Capping Species |
|---|---|
| $1 ) 6 eq ( 1 ) + 1 eq ( 3 ) {\to }^{B ( C 6 F 5 ) 3} oligomer 13 a$ | SiH₂ |
| $2 ) 6 eq ( 3 ) + 1 eq ( 1 ) {\to }^{B ( C 6 F 5 ) 3} oligomer 31 a$ | Si(OEt)₂ |
| $3 ) 3 eq ( 1 ) + 1 eq ( 4 ) {\to }^{B ( C 6 F 5 ) 3} oligomer 14 a$ | SiH₂ |
| $4 ) 6 eq ( 4 ) + 1 eq ( 1 ) {\to }^{B ( C 6 F 5 ) 3} oligomer 41 a$ | Si(CH₃)OEt |
| $5 ) 6 eq ( 2 ) + 1 eq ( 3 ) {\to }^{B ( C 6 F 5 ) 3} oligomer 23 a$ | Si(CH₃)H |
| $6 ) 3 eq ( 3 ) + 1 eq ( 2 ) {\to }^{B ( C 6 F 5 ) 3} oligomer 32 a$ | Si(OEt)₂ |
| $7 ) 3 eq ( 2 ) + 1 eq ( 4 ) {\to }^{B ( C 6 F 5 ) 3} oligomer 24 a$ | Si(CH₃)H |
| $8 ) 3 eq ( 4 ) + 1 eq ( 2 ) {\to }^{B ( C 6 F 5 ) 3} oligomer 42 a$ | Si(CH₃)OEt |

Building an oligomer can occur in stages, and in some embodiments a higher molecular weight oligomer can be produced by reacting an oligomer with additional monomer of a same or different type as was used in the initial reaction. For instance, oligomer 13a can attach to cyclic carbosilane monomer “3” to build a higher molecular weight oligomer identified as oligomer 13b. If pendant Si—O-Et or Si-(OEt)₂ groups are desired, an excess of monomer 3 or monomer 4 can be reacted with a previously formed oligomer. To keep the periphery of the oligomer capped with SiH₂ groups, as in 13a, the additional monomer can be added in an amount where the equivalents of monomer do not exceed the equivalents of SiH₂ groups available on oligomer 13a. The second generation oligomer 13b can be reacted with additional monomer in a similar manner to produce an even higher molecular weight oligomer, 13c. Example embodiments of multi-step oligomer syntheses are provided below. Oligomers 13b and 13c include components from monomers 1 and 3. Oligomers 134a and 134b include oligomers from monomers 1, 3 and 4.

$$\begin{matrix}6 eq ( 1 ) + 1 eq ( 3 ) {\to }^{ B ( C 6 F 5 ) 3 } 13 a & 1 a ) \\ 13 a + \frac{1}{6} eq ( 3 ) {\to }^{ B ( C 6 F 5 ) 3 } 13 b & 1 b ) \\ 13 b + \frac{1}{36} eq ( 3 ) {\to }^{ B ( C 6 F 5 ) 3 } 13 c & 1 c ) \\ 6 eq ( 1 ) + 1 eq ( 3 ) {\to }^{ B ( C 6 F 5 ) 3 } 13 a & 1 a ) \\ 13 a + \frac{1}{3} eq ( 4 ) {\to }^{ B ( C 6 F 5 ) 3 } 134 a & 1 d ) \\ 134 a + \frac{1}{9} eq ( 4 ) {\to }^{ B ( C 6 F 5 ) 3 } 134 b & 1 c )\end{matrix}$$

Porogens

Additional embodiments can incorporate porogens into the precursor film layer and into the dielectric film. Porogens may be useful in creating porosity and can be sacrificed or otherwise removed from the layer/film to leave a void in the film. The type and concentration of porogens chosen can determine the size of the pores and the total porosity in the cross-linked dielectric layer. Different porogens may be used within the same layer. Porogens may be molecules that can be removed from the layer after it has been cross-linked. In some specific example embodiments, porogens can have dimensions (widths, lengths, and heights or radii) that are from 0.25 nm to 2 nm. In alternate embodiments, the porogen functional groups have dimensions that are from 0.25 nm to 0.5 nm or from 0.5 nm to 5 nm. Pore sizes in the resulting films have dimensions (widths, lengths, and heights or radii, depending on the shape of the pore) that are from 0.25 nm to 2 nm (or from 0.25 nm to 0.5 nm or from 0.5 nm to 5 nm), depending on the porogen chosen. Pore sizes can also be multiples of the porogen shapes depending on the number of neighboring porogen-porogen agglomerates. Further, porogens can decompose (upon heating, UV curing, or electron beam curing, for example) with approximately 100% volatile yield (approximately indicating 80%±20%). Porogens can include, for example, block copolymers, surfactants, star polymers and oligosaccharides. Specific oligosaccharides include cyclic oligosaccharides such as cyclodextrin. Exemplary cyclodextrin porogens may include, for instance, 5 to 10 glucose residues.

Porogens may be chemically bound, such as through covalent bonding in some embodiments, with precursor oligomers. In other embodiments, the porogens may be mixed with the oligomer but need not be chemically attached to the oligomer or to the monomers from which the oligomer is formed. The porogens may be mixed with precursor oligomers prior to coating and can be evenly dispersed to avoid aggregating into large pockets of volatile organic material. Porogens may include functional groups that can aid in dispersing the porogens efficiently in the precursor oligomer. Porogens may also be functionalized to avoid attraction to other porogens and thus reduce or avoid aggregation and agglomeration. For instance, capping hydroxyl groups on a cyclodextrin molecule with alkyl or silyl (—OSiR₃) groups can improve compatibility with the precursor oligomers described herein while reducing attraction between cyclodextrin molecules. Solvent systems for porogen embodiments may be the same or different than those used with the cyclic carbosilane oligomers and may be, for example, aliphatic hydrocarbons such as hexane, heptane, octane and isooctane or aromatic hydrocarbons such as benzene, toluene, xylene and ethyl benzene.

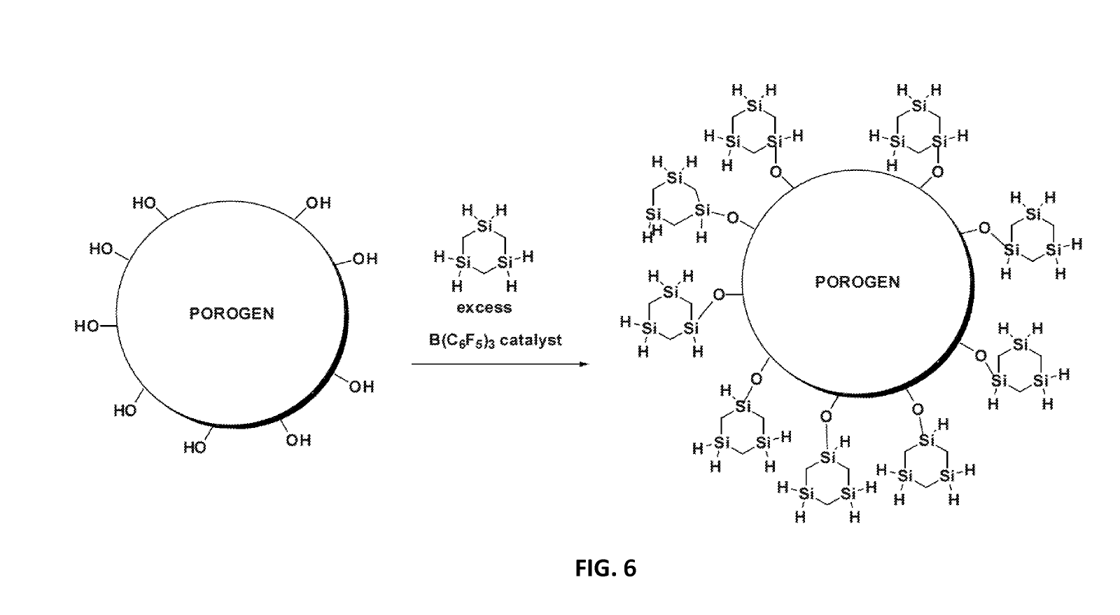

In embodiments where a porogen is chemically bound to the precursor oligomer, the porogen may be functionalized so that it reacts with the low k precursor oligomer before or after both have been coated on the substrate surface. The linking of the porogens with the precursor can be initiated, for example, by activation energy such as by heat, radiation, acid or base. The chemical linking of the porogen with the precursor oligomer prior to thermal baking can provide for improved dispersion and subsequently small, consistently sized pores. In some embodiments, porogens that exhibit available hydroxyl groups (such as cyclodextrins) can be functionalized by decorating them with cyclic carbosilanes such as those illustrated in FIG. 4 to functionalize the porogens with, for example, Si—H or Si—OEt capping. An example illustrating the functionalizing of a porogen with monomer (1) of FIG. 4 is shown in FIG. 6. Each of the available hydroxyl groups has been reacted with a cyclic carbosilane providing for multiple reactive groups that can be used to chemically attach the porogen to the precursor oligomer.

Controlling porosity can help in selecting specific k values for cyclic carbosilane films. In some embodiments, porosity of the film can correlate directly with k value. For example, films having a porosity of from 62% to 42% may exhibit k values from 1.60 to 2.25; porosities of 42% to 34% may exhibit k values of 2.25 to 2.50; and porosities of 34% to 0.1% may exhibit k values of 2.50 to 3.50. In a similar manner, the stiffness of the film may be controlled by targeting the porosity of the film. For example, the cyclic carbosilane films disclosed herein having a porosity of from 62% to 42% may exhibit a Young's modulus of from 1.60 to 2.25; porosities of 42% to 34% can exhibit a Young's modulus of 2.25 to 2.50; and porosities of 34% to 0.1% can result in a Young's modulus of 2.50 to 3.50.

Cross-Linking

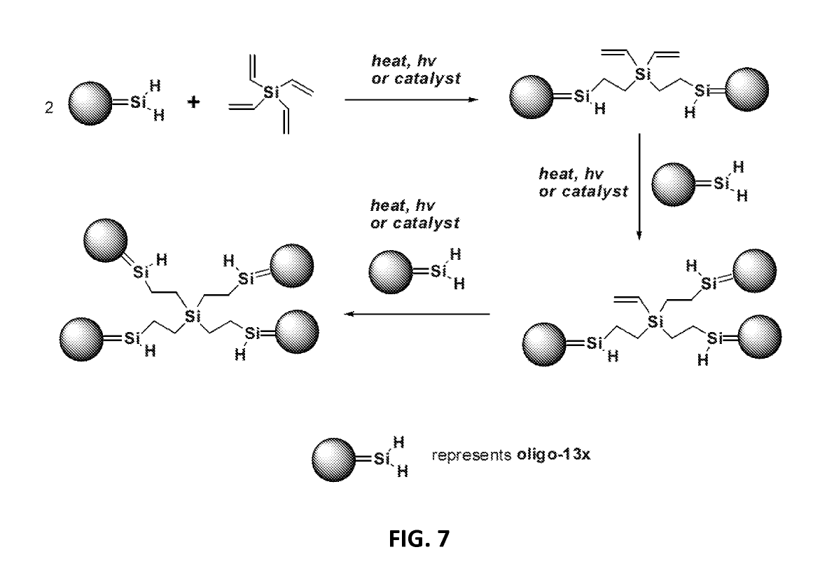

To form a stable low k interlayer dielectric (ILD) in accordance with some embodiments of the present invention, the oligomeric precursor(s) can be cross-linked after being applied to the substrate. For example, the precursors can be spin-coated or otherwise deposited onto the substrate at a desired thickness and then cross-linked using any one of several methods. Cross-linking agents may be selected based on the specific precursor oligomers that are being linked. For example, if the oligomers present SiH groups, multifunctional molecules such as silanes containing C═C and C═O bonds may be used. These molecules include tetravinylsilane and tetraallylsilane, for example. A cross-linking pathway utilizing tetravinylsilane, in accordance with some such embodiments, is illustrated in FIG. 7 where four oligomeric species such as oligomer 13x are linked together via reaction with the four vinyl groups. The cross-linking can be facilitated, for example, by heat, radiation and/or a chemical catalyst. In some embodiments, temperature may range from 150° C. to 500° C., 200° C. to 450° C.°, 250 C.° to 400 C.° and 300 C.° to 375 C.°. UV activation may occur using a broad range of wavelengths and with some activators, any wavelength below 300 nm can be effective. Intensity of UV radiation should be adequate to fully cross-link the oligomers. In some embodiments an intensity of from 0.1 to 1.0 W/cm² has been found effective. Exposure time can be adjusted for specific film systems as well as specific wavelengths and radiation intensity. To achieve complete crosslinking, times from 5 seconds to 20 minutes have been used in many embodiments.

Si—H bonds can also be reacted with compounds including air, or alcohol or Si—OR functionality. In other embodiments, a cross-linking agent such as water can be added to the precursor to link Si—H moieties. The choice of a specific cross-linking agent can also be based on the desired composition of the dielectric layer. For example, the ratio of C to O to Si in the layer can be tailored by using specific cross-linking agents. Cross-linking may be activated, for example, thermally or via a catalyst. Catalysts include, for example, strong acids or Lewis acids. To avoid cross-linking during the spin coating process, an acid catalyst can be introduced in a masked form that releases acid only after activation, such as thermal activation via a thermal acid generator (TAG) or photochemical activation via a photoacid generator (PAG). Exemplary photo acid generators include diaryliodonium and triarylsulfonium salts possessing weakly coordinating counter anions such as trifluoromethanesulfonate, nonaflurorbutanesulfonate, hexafluorophosphate, tetrafluoroborate, para-toluenesulfonate. Examples of neutral photoacid generators include those in the arylsulfonate family such as phenyltrifluoromethanesulfonate and those in the N-sulfonated amine and imides family such as N-trifluoromethanesulfonatomaleimide. Other classes of compounds common in the photolithographic and photopolymerization fields are also useful in various example embodiments of the invention. Examples of photobase generators include amines protected with photodecomposable nitrobenzylcarbamate or other carbamate groups. Other classes of compounds common in the photolithographic and photopolymerization fields and used as PAGs and PBGs are also useful in embodiments of the invention. Through the introduction of less stable substituents, the above described photoacid and photobase generators can be tuned to also behave as thermal acid and thermal base generators, respectively. For example, sulfonium salts possessing two aryl substituents and one alkyl substituent can behave as thermal acid generators. Additionally, due to the thermal instability of carbamate towards the release of CO₂, common photobase generators can also serve as thermal base generators in films. Typical temperatures for carbamate-containing TAGs are temperatures between 200 and 400° C.

In a similar manner, Lewis acids can be released using thermal Lewis acid generators (ThLAGS) or photochemical Lewis acid generators (PhLAGS). The masked activator, e.g., PhLAG or ThLAG, can be stably incorporated into the precursor oligomers and polymerization can be delayed indefinitely but initiated on demand by the application of, for instance, heat or UV radiation. For instance, heating of the film can thermally activate the components to provide the energy necessary for Si—O—Si (or other Si—XL-Si) reactions to occur. Some compounds can act as both a ThLAG and a PhLAG. Such compounds include the triphenylsulfonium salt of B(C₆F₅)₃ that can be irradiated by UV light (e.g., 254 nm) to release the strong Lewis acid B(C₆F₅)₃. Analogous methods for base generation can also be used. Lewis acid generators, both ThLAGs and PhLAGs, may be also be used to link existing precursor oligomers with cyclic carbosilane monomers including those used to build the oligomer initially. For instance, SiOEt capped monomers such as monomers 3 and 4 from FIG. 2 can be added to an Si—H capped oligomer such as oligomer 13a along with a ThLAG or PhLAG and then the mixture can be spin coated onto the substrate. Upon unmasking via heat or UV radiation, the available Lewis acid can catalyze the reaction between the oligomer and the monomer, leading to a cross-linked film that can be a low k dielectric film such as an ILD. Porogens may be functionalized in a similar manner and may be cross-linked integrally with the precursor oligomers into the dielectric layer.

Cross-linked layers comprised of the carbosilane compounds described herein can exhibit low k values. For instance, the dielectric constant (k) values for the cross-linked carbosilane layers may be less than 3.2, less than 3.0, less than 2.5, less than 2.0, less than 1.8 or less than 1.6. Specific ranges for k values can include 1.6 to 3.6, 2.6 to 3.6, 1.6 to 2.6, 1.6 to 2.2, 2.2 to 2.6, 1.0 to 2.5, 1.0 to 1.8 and 1.0 to 1.6. In other embodiments, films possessing higher k values may be preferred and can be produced using cyclic carbosilanes. For example, these cross-linked films may exhibit k values of greater than 3.0, greater than 3.2 and greater than 3.4. Specific ranges include 3.0 to 4.0, 3.2 to 3.6 and 3.4 to 3.5. Dielectric constant values are measured using a CV dot technique in which the film is deposited on a highly doped Si substrate and metallic dots are deposited on top of the film. The dielectric constant across the film is then measured.

Improving Dielectric Constant, Hydrophobicity and Chemical Resistance

After the dielectric layer has been hard baked or after the dielectric layer has been etched and cleaned, it has been discovered that in some cases residual hydroxyl groups may remain that can render portions of the layer hydrophilic. These portions may occur after hard bake, it is believed, when Si—H groups, Si—OEt groups or porogen residues are converted to Si—OH groups by thermal oxidation. These portions may also occur, it is believed, after SiCH₃, SiH and/or Si—CH₂—Si groups are converted to SiOH by dry etching and wet cleaning chemistry. The methods described below can be used to reduce, remove or cap these Si—OH reactive groups and improve the mechanical and chemical properties of the layer. These processes can result in better mechanical strength, higher chemical stability, reduced electrical leakage, reduced dielectric constant and a higher electrical field at which the layer breaks down. Chemical stability can be increased to resist chemical attack from materials including strong acids, bases and oxidizers such as, for example, HF, KOH, TMAH, H₂0₂, HCl, NH₃ and/or mixtures of these. Chemical stability with respect to other typical semiconductor etchants and process agents can also be improved. In general, chemical stability means that the film is significantly resistant to chemical degradation. For example, chemically stable films can be evaluated by placing a sample of the film in a solution (wt %) of 0.5% HF (at 23° C.), 1.0% KOH (at 50° C.), 15% TMAH (tetramethylammonium hydroxide) (at 60° C.), or 30% H₂O₂ (at 50° C.) for 10 minutes. Resistant to degradation equates to 10 nm or less of film loss and 5% or less change in refractive index.

Some embodiments of the low k films described herein can have atomic percent compositions in the range of 30-45%, 45-60% or 30-60% C; 25-35%, 35-45% or 25-45% Si; and 10-20%, 20-30% or 10-40% O (atomic percent).

Additionally, the resulting films can be hydrophobic. As used herein, hydrophobic means that the films do not absorb or adsorb significant amounts of water from the atmosphere. In embodiments of the invention, less than 5% water uptake (as a volume of water taken up by the film to total volume of the film) is observed for the hydrophobic carbosilane films as measured by ellipsometric porosimetry in a saturated H₂O atmosphere at room temperature (20 to 23.5° C.). In additional embodiments, less than 3% water uptake or less than 1.5% water uptake or less than 1.1% water uptake or less than 1% water uptake is observed for the hydrophobic carbosilane films as measured by ellipsometric porosimetry.

In one set of embodiments, a cross-linked layer can be treated by reacting with a silylating agent to cap any available Si—OH groups. Silylating agents may include, for example, dimethylaminotrimethyl silane, hexamethyldisilazane, hexamethyldisiloxane, trimethoxysilanes and dimethyldimethoxysilane. In another procedure, that may be used independently or in conjunction with the silylating process, the cross-linked layer is exposed to light in the UV to visible range while being heated to a temperature of 100-450° C. The exposure period may be relatively short, for instance, from 1 second to 20 minutes. Table 1, below, provides results obtained after silylation repair and UV treatment of a layer made from oligomer 13a and a cyclodextrin porogen. After removal of the porogen, the cross-linked layer was irradiated with UV at an intensity of 1.0 W/cm² for a period of 1 minute at a temperature of 400° C. These results show that the UV cure treatment alone provides significant improvement in properties such as k value, porosity, water uptake (hydrophobicity) and chemical resistance to acids and bases. Also, unlike silylation repair, UV cure typically does not result in significant loss in porosity.

TABLE 1

| | Oligomer/porogen | | | | |
|---|---|---|---|---|---|
| | 13a/CD2 | 13a/CD2 | 13a/CD2 | 13a/CD2 | 13a/CD2 |
| Silylation Repair | No | Yes | No | No | Yes |
| UV Cure at 400° C. | No | No | D/1 m | D/3 m | H/6 m |
| Porosity (% vol) | 52.7 | 47.8 | 52.2 | 50.4 | 47.2 |
| Water Uptake (% vol) | 10.9 | 1.08 | 1.5 | 2.6 | 2.7 |
| Time (min) to 10 nm loss | 0.16 | 2 | >5 | | >10 |
| w/KOH | | | | | |
| Time (min) to 10 nm loss w/HF | 2 | 6 | >10 | | >10 |
| Leakage (A/cm2 at 2 MV/cm) | | | 1.10E−08 | | |
| BDF (MV/cm) | | | >3.1 | | |
| Dielectric Constant (k) Value | 2.85 | 2.2 | 1.9 | 1.93 | 1.98 |
| Young's Modulus (GPa) | 2.1 | 2.0 | 2.6 | 5.52 | 4.26 |

In some embodiments, the hydrophobicity of cyclic carbosilane films can be repaired (reduction in OH groups) without increasing the density of the film and without reducing the porosity of the film. For instance, the film can be irradiated with UV light, as described above, in the absence of silylating agents. It has been found that such treatment can reduce the presence of OH groups by more than 50%, more than 90% or more than 95%. Films that have been repaired by silylation may differ from those repaired by UV in that they have different densities and different IR stretch frequencies. For example, silylating agent repair will result in cyclic carbosilane films that exhibit stretch frequencies of 1264 cm⁻¹ (FWHM=8 cm⁻¹) for one silylating agent or 1255 cm⁻¹ (FWHM=10 cm⁻¹) for a second silylating agent. In comparison, a film that has been repaired only via UV treatment exhibits approximately equal components (40/60 to 60/40) of 1274 cm⁻¹ (FWHM=8 cm⁻¹) and 1264 cm⁻¹ (FWHM=10 cm⁻¹). This means that silylating agent repaired and UV repaired films can be differentiated by comparing these peaks. Fingerprinting can also be used to differentiate these films by comparing the relative heights of peaks at 1360 cm⁻¹ (Si—CH2-Si), 1000-1200 cm⁻¹ (Si—O—Si), and 800 cm⁻¹ (Fingerprint region).

In general, a spin-on-dielectric film (SOD) is a dielectric film created by spinning a solution to distribute it across a surface and then solidifying the solution on the surface. A liquid form of the film is placed in the center of the substrate (such as a wafer). The substrate is spun causing the liquid film material to distribute across the wafer surface. The thickness of the resulting film depends in part on the viscosity of the liquid film and in part on the spinning rate among other parameters. Excess liquid film material is spun off the substrate.

In general, a low-k dielectric material is a dielectric material that has a lower dielectric constant than silicon dioxide (SiO₂). Silicon dioxide has a dielectric constant of 3.9. The use of low-k dielectric materials in integrated circuit devices has enabled continued device size reduction. Although a variety of materials have lower dielectric constants than SiO₂ not all materials are suitable for integration into integrated circuits and integrated circuit manufacturing processes.

An interlayer dielectric (ILD) or inter metal dielectric (IMD) film is the insulating material used between metal conductors and devices (such as transistors) in integrated circuit devices.

Semiconductor Device with Low K Dielectric

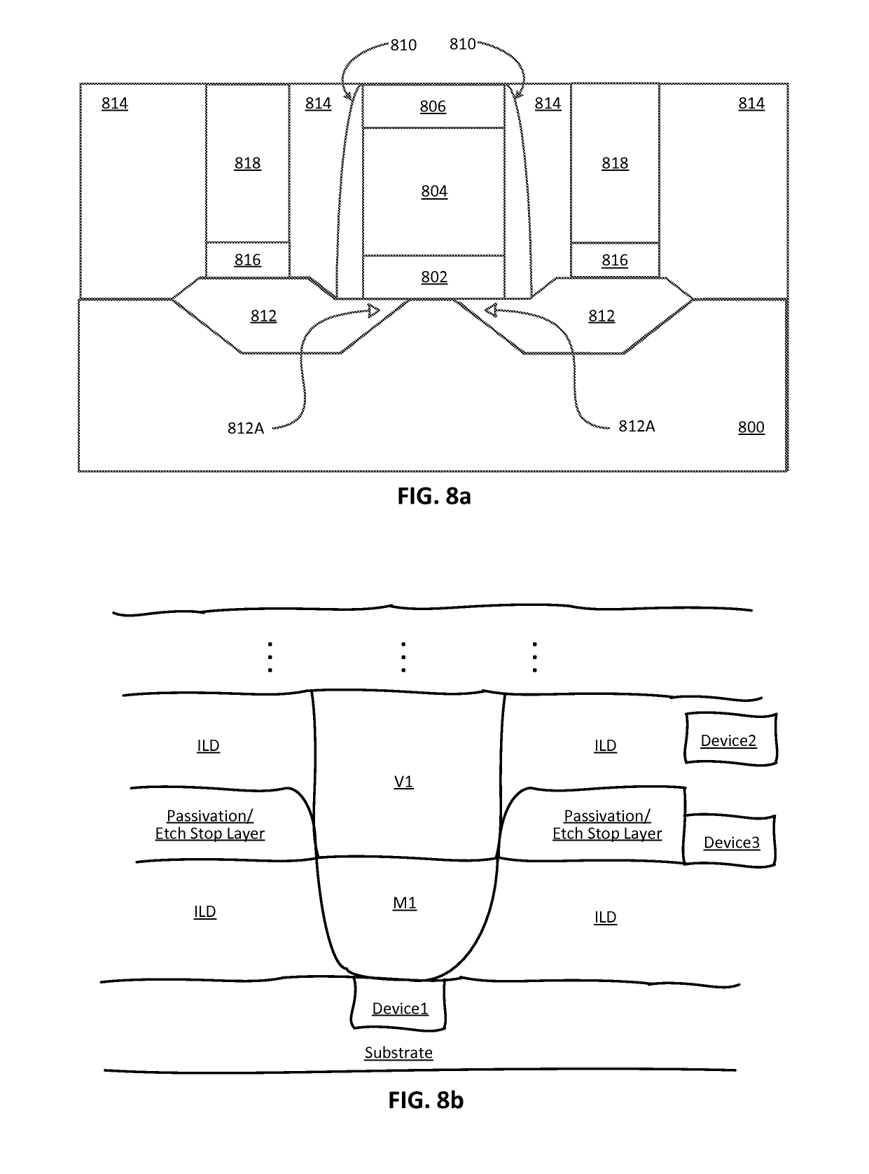

FIG. 8a shows a cross-section side view of an example semiconductor structure configured with a low-k interlayer dielectric in accordance with one embodiment of the present invention. This example case includes a MOS transistor formed on substrate 800. As will be appreciated, the transistor may be a planar configuration, or a non-planar configuration where the depicted side-view cross-section is taken parallel along the fin. As will be further appreciated, any number of semiconductor devices may employ a low-k dielectric or insulator material as described herein, and the claimed invention is not intended to be limited to any particular type of integrated circuit; rather, the disclosed low-k materials have broad application.

As can be seen, a gate stack is formed over a channel region of the device, and includes a gate dielectric layer 802, a gate electrode 804, and an optional hardmask 806. Spacers 810 are formed adjacent to the gate stack. The gate dielectric 802 can be, for example, any suitable oxide such as silicon dioxide (SiO₂) or high-k gate dielectric materials. Examples of high-k gate dielectric materials include, for instance, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In general, the thickness of the gate dielectric 802 should be sufficient to electrically isolate the gate electrode 804 from the source and drain contacts. In some specific example embodiments, a high-k gate dielectric layer 802 may have a thickness in the range of 5 Å to around 100 Å thick (e.g., 10 Å). In some embodiments, additional processing may be performed on the high-k gate dielectric layer 802, such as an annealing process to improve the quality of the high-k material. The gate electrode 804 material can be, for example, polysilicon, silicon nitride, silicon carbide, or a metal layer (e.g., tungsten, titanium nitride, tantalum, tantalum nitride) although other suitable gate electrode materials can be used as well. The gate electrode 804 material, which may be a sacrificial material that is later removed for a replacement metal gate (RMG) process, has a thickness in the range of about 10 Å to 500 Å (e.g., 100 Å), in some example embodiments. The optional gate hard mask layer 806 can be used to provide certain benefits or uses during processing, such as protecting the gate electrode 804 from subsequent etch and/or ion implantation processes. The hard mask layer 806 may be formed using typical hard mask materials, such as such as silicon dioxide, silicon nitride, and/or other conventional insulator materials. The gate stack can be formed as conventionally done or using any suitable custom techniques (e.g., conventional patterning process to etch away portions of the gate electrode and the gate dielectric layers to form the gate stack). Each of the gate dielectric 802 and gate electrode 804 materials may be formed, for example, using conventional deposition processes such as chemical vapor deposition (CVD), atomic layer deposition (ALD), spin-on deposition (SOD), or physical vapor deposition (PVD). Alternate deposition techniques may be used as well, for instance, the gate dielectric 802 and gate electrode 804 materials may be thermally grown. As will be appreciated, any number of other suitable materials, geometries, and formation processes can be used to implement an embodiment of the present invention, so as to provide a semiconductor device or structure having a low-k dielectric as described herein. The spacers 810 may be formed, for example, using conventional materials such as silicon oxide, silicon nitride, or other suitable spacer materials. The width of the spacers 810 may generally be chosen based on design requirements for the transistor being formed.

Any number of suitable substrates can be used to implement substrate 800, including bulk substrates, semiconductors-on-insulator substrates (XOI, where X is a semiconductor material such as silicon, germanium, or germanium-enriched silicon), and multi-layered structures, including those substrates upon which fins or nanowires can be formed prior to a subsequent gate patterning process. In some specific example cases, the substrate 800 is a germanium or silicon or SiGe bulk substrate, or a germanium or silicon or SiGe on oxide substrate. Although a few examples of materials from which the substrate 800 may be formed are described here, other suitable materials that may serve as a foundation upon which semiconductor devices having a low-k dielectric may be built falls within the spirit and scope of the claimed invention.

With further reference to FIG. 8a, the example device also includes source/drain regions 812, which may be p-type or n-type. As will be appreciated, the composition, doping, and geometry of the source/drain regions 812 will vary depending on factors such as the composition of the substrate 800, polarity of the device, the use of grading for lattice matching/compatibility, and the overall desired thickness of the total source/drain deposition. Numerous material system and doping configurations can be implemented, as will be appreciated. In some example embodiments, the source/drain regions 812 are implemented with doped silicon or silicon germanium. Liners and/or buffer layers may be provided as well, as sometimes done. In the example embodiment shown, the source/drain regions 812 are implemented with a raised configuration and include source/drain extensions 812A or so-called tip regions in relatively close proximity to the channel region so as to impart a larger hydrostatic stress on the channel. Other embodiments may include tip regions implemented with a diffusion-based process where the tip regions generally do not induce a strain on the channel region.

As will be appreciated, any number of other transistor configurations may be implemented with an embodiment of the present invention. For instance, the channel may be strained or unstrained, and the source/drain regions may or may not include tip regions formed in the area between the corresponding source/drain region and the channel region. In this sense, whether a transistor structure has strained or unstrained channels, or source/drain tip regions or no source/drain tip regions, is not particularly relevant to various embodiments of the present invention, and the claimed invention is not intended to be limited to any particular such structural features. Rather, any number of transistor structures and types can benefit from employing a low-k dielectric as described herein.

As can be further seen, the device includes an insulator layer 814 that has been deposited and then planarized down to the hard mask 806. The insulator layer 814 may be formed, for example, using low-k dielectric (insulator) materials as provided herein and may or may not include pores/voids. In such applications, the insulator layer 814 is sometimes referred to as an interlayer dielectric (ILD), and provides electrical insulation between the source/drain and gate electrodes, as well as between neighboring devices. The ILD also can be used to provide structural support.

The example embodiment of FIG. 8a further includes contact resistance reducing metal 816, which in some embodiments include silver, nickel, aluminum, titanium, gold, gold-germanium, nickel-platinum or nickel-aluminum, and/or other such resistance reducing metals or alloys. The contact plug metal 818, which in some embodiments includes aluminum or tungsten, although any suitably conductive contact metal or alloy can be used, such as silver, nickel-platinum or nickel-aluminum or other alloys of nickel and aluminum, or titanium, using conventional deposition processes. Metalization of the source/drain contacts can be carried out, for example, using a silicidation process (generally, deposition of contact metal and subsequent annealing).

FIG. 8b shows a cross-section side view of an example semiconductor structure configured with a low-k interlayer dielectric in accordance with another example embodiment of the present invention. As can be seen, FIG. 8b is drawn to reflect example real world process limitations, in that the features are not drawn with precise right angles and straight lines. This example semiconductor structure includes a substrate with multiple layers of dielectric (ILD) and interconnect metal (via V1 and metal M1) formed thereon, with various devices formed in the substrate and some of the layers (such as Device1, Device2 and Device3), which can be, for example, transistors, diodes, capacitors, inductors or any other passive and/or active devices). As will be appreciated, actual details of the devices are not provided as such details are not particularly relevant or otherwise necessary for understanding of the claimed invention. The ILD material can be implemented with dielectric material as described herein and can be used, for example, to separate conductors from other conductors, or conductors from devices, or devices from devices, etc. The semiconductor configurations that can utilize such dielectric materials as provided herein are effectively unlimited, and FIGS. 8a-b are merely provided as examples only and are not intended to limit the claimed invention. Factors such as etch selectivity, desired electrical isolation, and/or distance between conductive features to be isolated can be considered in implementing a given configuration.

Example System

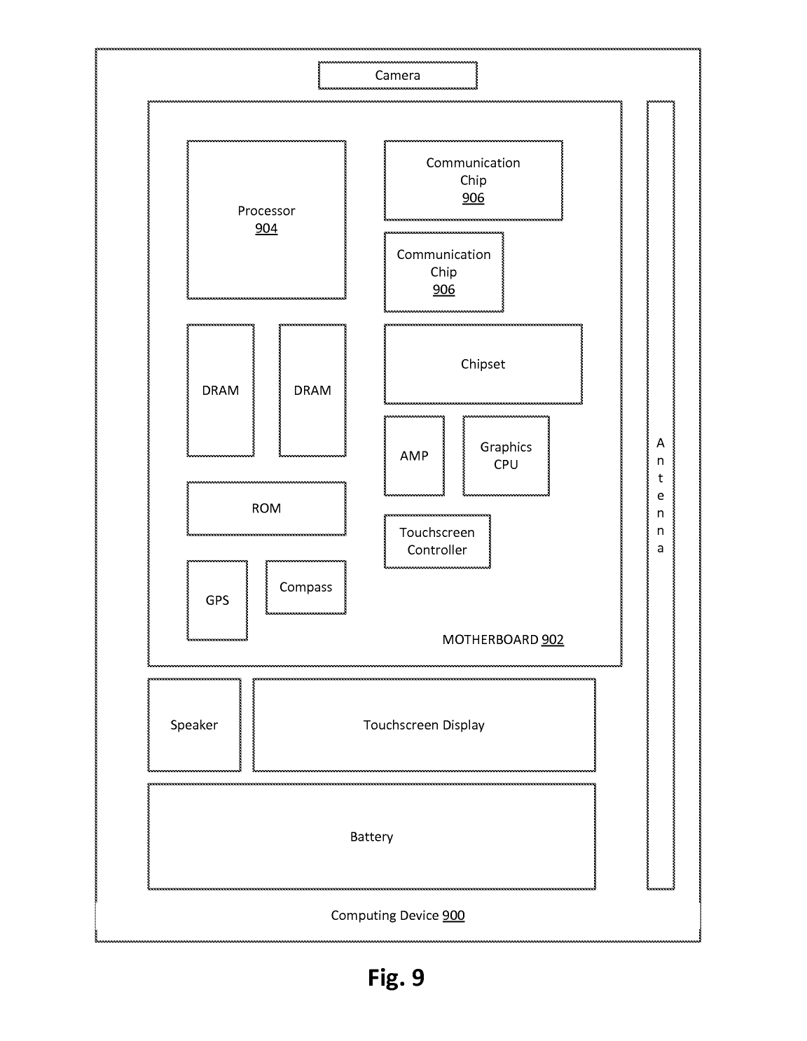

FIG. 9 illustrates a computing system implemented with one or more integrated circuits implemented with a low-k dielectric configured in accordance with an embodiment of the present invention. As can be seen, the computing system 900 houses a motherboard 902. The motherboard 902 may include a number of components, including but not limited to a processor 904 and at least one communication chip 905 (two are shown in this example), each of which can be physically and electrically coupled to the motherboard 902, or otherwise integrated therein. As will be appreciated, the motherboard 902 may be, for example, any printed circuit board, whether a main board or a daughterboard mounted on a main board or the only board of system 900, etc. Depending on its applications, computing system 900 may include one or more other components that may or may not be physically and electrically coupled to the motherboard 902. These other components may include, but are not limited to, volatile memory (e.g., DRAM), non-volatile memory (e.g., ROM), a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). Any of the components included in computing system 900 may include one or more integrated circuits implemented with a low-k dielectric as described herein. In some embodiments, multiple functions can be integrated into one or more chips if so desired (e.g., for instance, note that the communication chips 906 can be part of or otherwise integrated into the processor 904).

The communication chip 906 enables wireless communications for the transfer of data to and from the computing system 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing system 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing system 900 includes an integrated circuit die packaged within the processor 904. In some embodiments of the present invention, the integrated circuit die of the processor 904 includes one or more transistors or other integrated circuit devices implemented with a low-k dielectric as described herein. The term “processor” may refer to any device or portion of a device that processes, for instance, electronic data from registers and/or memory to transform that electronic data into other electronic data that may be stored in registers and/or memory.

The communication chip 906 may also include an integrated circuit die packaged within the communication chip 906. In accordance with some such example embodiments, the integrated circuit die of the communication chip 906 includes one or more transistors or other integrated circuit devices implemented with a low-k dielectric as described herein. As will be appreciated in light of this disclosure, note that multi-standard wireless capability may be integrated directly into the processor 904 (e.g., where functionality of any chips 906 is integrated into processor 904, rather than having separate communication chips). Further note that processor 904 may be a chip set having such wireless capability. In short, any number of processor 904 and/or communication chips 906 can be used. Likewise, any one chip or chip set can have multiple functions integrated therein.

In various implementations, the computing system 900 may be a laptop, a netbook, a notebook, a smartphone, a tablet, a personal digital assistant (PDA), an ultra-mobile PC, a mobile phone, a desktop computer, a server, a printer, a scanner, a monitor, a set-top box, an entertainment control unit, a digital camera, a portable music player, or a digital video recorder. In further implementations, the system 900 may be any other electronic device that processes data or employs transistor devices or other semiconductor devices implemented with a low-k dielectric as described herein (e.g., CMOS devices having both p and n type devices configured with low-k ILDs). As will be appreciated in light of this disclosure, various embodiments of the present invention can be used to improve performance on products fabricated at any process node (e.g., in the micron range, or sub-micron and beyond) by allowing for the use of integrated circuit devices implemented with a low-k dielectric as described herein.

In additional embodiments, a device includes a low-k dielectric layer that can include cross-linked carbosilane units having a ring structure including C and Si, wherein the cross-linked cyclic carbosilane units are capped with Si—H or Si—H₂. In another set of embodiments, a device comprises a dielectric film disposed on a substrate, the film comprised of cross-linked cyclic carbosilane units having a ring structure including C and Si, wherein at least a first cyclic carbosilane unit is linked to at least three adjacent cyclic carbosilane units. In yet another set of embodiments, a device comprises a dielectric film disposed on a substrate, the film comprised of cyclic carbosilanes and having a K value of less than 2.2 and a time to 10 nm loss of greater than 10 minutes for hydrofluoric acid or potassium hydroxide.

Any adjacent cross-linked carbosilane units in these devices can be linked via a cyclic Si atom in each of the carbosilane units. In some embodiments, at least some of the cyclic carbosilane units can be covalently bonded to greater than two adjacent cyclic carbosilane units. In many embodiments, the cyclic carbosilane units include an even number of cyclic atoms and equal numbers of C and Si. For instance, the cyclic carbosilane units may include 3 Si and 3 C atoms. The Si atoms may be covalently linked by an atom such as oxygen. The cross-linked layer in these embodiments may include carbosilane units that are structurally identical or structurally different. In some embodiments, the low-k layer may be disposed on a substrate and the substrate may have a k value that is greater than that of the low-k layer. In various embodiments, the k value may be lower than that of the substrate, less than 2.5 or less than 2.5 and greater than 1.6. Examples of materials that can be used for substrates include silicon, silicon dioxide, germanium, indium, antimonide, lead telluride, indium arsenide, indium phosphide, gallium arsenide or gallium antimonide. In some embodiments, all of the bonds between adjoining cyclic carbosilane units are between cyclic Si atoms and none of the bonds are between cyclic carbon atoms. Two adjoining cyclic carbosilane units may be joined via an oxygen atom. Porosity of different embodiments can be from 1 to 65% or 35 to 50% or 45 to 65%. In many embodiments, the low k cross-linked film can be essentially free (non-detectable by NMR) of Si—O—R groups such as Si—O-Et. Additional embodiments may exhibit a water uptake of less than 5% or less than 1.0% by volume. In some cases, all of the cyclic carbosilane units are capped with Si—H and in other cases with Si—H₂, or a mixture of the two. In other embodiments, the dielectric film exhibits a time to 10 nm loss of greater than 10 minutes for hydrofluoric acid. In yet other embodiments, the dielectric film exhibits a time to 10 nm loss of greater than 10 minutes for potassium hydroxide. The dielectric films can be used to make a semiconductor device.

Different embodiments of the dielectric film may be made by methods that include disposing an oligomeric precursor on a substrate wherein the precursor is comprised of cyclic carbosilanes. The precursor can be made by combining a first cyclic carbosilane monomer together with a second cyclic carbosilane monomer, that is the same as or different than the first, to form a carbosilane oligomer, coating the oligomer onto a substrate, and cross-linking the oligomer to form a hardened dielectric layer. The carbosilane monomers may comprise 6 member ring structures and may include 3 carbon atoms and 3 silicon atoms in the ring. The cyclic carbosilanes may be reacted in ratios of greater than or equal to 2:1, greater than or equal to 3:1; greater than or equal to 4:1, greater than or equal to 5:1 or greater than or equal to 6:1 on an equivalents basis. In some embodiments, the cyclic carbosilane units can be cross-linked using an initiator being at least one of a photo acid generator, a photo base generator, a thermal acid generator, a thermal base generator, a thermal Lewis acid generator and a photo Lewis acid generator. In some embodiments at least one cyclic carbosilane monomer comprises Si—H or Si—H₂ groups and a second cyclic carbosilane monomer comprises Si—OEt groups. In many embodiments, initiation can include heating and/or activation with radiation such as UV radiation. An oligomeric precursor may be mixed with or reacted with a porogen and in some embodiments the porogen may be functionalized. In embodiments using porogens, some or all of the porogens may be removed such as through volatilization. In various embodiments, the methods may also include coating a porogen onto a substrate, applying a porogen that is chemically attached to the oligomer, applying a porogen that is not attached to the oligomer, or functionalizing a porogen by attaching a cyclic carbosilane molecule to the porogen. Additional steps may include capping hydroxyl groups on a hardened dielectric film or UV curing the hardened dielectric film. In some cases, the UV curing reduces the hydroxyl group without significant loss of porosity. In some cases, the oligomers include carbosilane units that are bonded to at least three additional cyclic carbosilane units. Some specific embodiments may use cyclic carbosilane monomers selected from 1,3,5-Trisilacyclohexane, 1,1,3,3,5,5-hexaethoxy-1,3,5-trisilacyclohexane, 1,3,5-trimethyl-1,3,5-trisilacyclohexane, 1,3,5-triethoxy-1,3,5-trimethyl-1,3,5-trisilacyclohexane and 1,3,5-triethoxy-1,3,5-trisilacyclohexane. In additional embodiments, the first and second cyclic carbosilane monomers can be reacted in ratios of greater than or equal to 2:1, greater than or equal to 3:1; greater than or equal to 4:1, greater than or equal to 5:1 or greater than or equal to 6:1 on an equivalents basis.

The foregoing description of example embodiments of the invention has been presented for the purposes of illustration and description. It is not intended to be exhaustive or to limit the invention to the precise forms disclosed. Many modifications and variations are possible in light of this disclosure. It is intended that the scope of the invention be limited not by this detailed description, but rather by the claims appended hereto.

What is claimed is:

1. A device comprising:
a dielectric film disposed on a substrate, the film comprised of cross-linked cyclic carbosilane units having a ring structure including C and Si, wherein at least a first cyclic carbosilane unit is linked to at least four adjacent cyclic carbosilane units.

2. The device of claim 1 wherein the first cyclic carbosilane unit is linked via Si—O—Si linkages to each of the at least four separate cyclic carbosilane units.

3. The device of any of claim 1 wherein at least one cyclic Si atom in the first cyclic carbosilane unit is covalently bonded to two adjacent cyclic carbosilane units.

4. The device of claim 1 wherein the cyclic carbosilane units are essentially free of Si—O-Et groups.

5. The device of claim 1 wherein essentially all of the cyclic carbosilane units are capped with Si—H or Si—H₂.

6. The device of claim 1 wherein the cyclic carbosilane units are essentially free of Si—H groups.

7. The device of claim 1 wherein the cyclic carbosilane units are capped with Si—O-Et or Si(OEt)₂ groups.

8. The device of claim 1 wherein the film comprises two or more structurally distinct cyclic carbosilane units.

9. The device of claim 1 wherein the dielectric film has a k value of less than 2.2.

10. The device of any of claim 1 wherein the film has a k value lower than the k value of the substrate.

11. The device of claim 1 wherein the dielectric film has a porosity of between 35 and 65%.

12. A device comprising:
a dielectric film disposed on a substrate, the film comprised of cross-linked cyclic carbosilane units having a ring structure including C and Si, wherein the cross-linked cyclic carbosilane units are capped with Si—H or Si—H₂.

13. The device of claim 12 wherein adjacent cross-linked cyclic carbosilane units are linked via cyclic Si atoms in each cyclic carbosilane unit.

14. The device of claim 12 wherein the dielectric film has a k value of less than 2.6.

15. The device of claim 12 wherein the substrate is comprised of silicon, silicon dioxide, germanium, indium, antimonide, lead telluride, indium arsenide, indium phosphide, gallium arsenide or gallium antimonide.

16. The device of claim 12 wherein the two adjoining cyclic carbosilane units are linked via an oxygen atom.

17. The device of claim 12 wherein all adjoining cyclic carbosilane units are linked via Si atoms in the carbosilane ring.

18. The device of claim 12 wherein the dielectric film has a porosity of between 1 and 65%.

19. The device of claim 12 wherein the dielectric film has a porosity of between 35 and 65%.

20. The device of claim 12 wherein the Si—O-Et groups in the film are non-detectable by ¹H NMR.

21. The device of any of claim 12 wherein the film exhibits a water uptake of less than or equal to 5.0%.

22. The device of claim 12 wherein the cyclic carbosilane units comprise 6 member rings including three carbon atoms and three silicon atoms.

23. The device of claim 12 wherein the dielectric film exhibits a time to 10 nm loss of greater than 5 minutes for 0.5% HF or 1.0% KOH.

24. A semiconductor device comprising the device of claim 12.

25. A method of making a dielectric film, the method comprising:
joining a first cyclic carbosilane monomer together with a second cyclic carbosilane monomer different from the first to form a carbosilane oligomer;
coating the oligomer onto a substrate; and
cross-linking the oligomer to form a hardened dielectric layer.

26. The method of claim 25 further comprising reducing the number of hydroxyl sites on the dielectric layer in the absence of additional silylating agents.

27. The method of claim 26 wherein the number of hydroxyl sites is reduced by irradiating with UV radiation.
